(19) United States
(12) Patent Application Publication
(10) Pub. No.: US 2014/0188920 A1
(43) Pub. Date: Jul. 3, 2014

(54) SYSTEMS AND METHODS FOR CUSTOMIZED CONTENT

(71) Applicants: Sangita Sharma, Portland, OR (US); Giuseppe Raffa, Portland, OR (US); Chieh-Yih Wan, Beaverton, OR (US); David L. Graumann, Portland, OR (US)

(72) Inventors: Sangita Sharma, Portland, OR (US); Giuseppe Raffa, Portland, OR (US); Chieh-Yih Wan, Beaverton, OR (US); David L. Graumann, Portland, OR (US)

(21) Appl. No.: 13/728,548

(22) Filed: Dec. 27, 2012

(51) Int. Cl. G06F 17/30

(52) U.S. Cl. CPC G06F 17/30386
USPC 707/758

(57) ABSTRACT

Systems and methods to receive content and generate a playlist of content based at least in part on content interests and/or preferences of occupants of a vehicle is disclosed. The playlist may further be generated based on user interests and/or preferences of multiple occupants of the vehicle. In addition, a drive context of the vehicle may be used in the selection of content for receiving and/or rendering.

### TECHNICAL FIELD

This disclosure generally relates to systems and methods for providing content, and more particularly, customized content.

### BACKGROUND

Vehicles, such as cars, may have one or more elements and/or components for rendering content, such as music, video, audio and video, or the like. This content may be rendered on the display screens and/or speakers disposed within the cabin of a vehicle. Often times, the driver and/or passengers of the vehicle may have specific interests in particular types for genres of content. In some cases, the interests of individuals within the vehicle may overlap and at other times they may not.

### BRIEF DESCRIPTION OF THE FIGURES

Reference will now be made to the accompanying drawings, which are not necessarily drawn to scale, and wherein:

FIG. 1 is a simplified schematic diagram of an example vehicle cockpit with a driver and passengers within along with an in vehicle infotainment system in accordance with embodiments of the disclosure.

FIG. 2 is a simplified block diagram illustrating an example architecture for providing customized content within the vehicle of FIG. 1 in accordance with embodiments of the disclosure.

FIG. 3 is a flow diagram illustrating an example method of providing an assembly of content in accordance with embodiments of the disclosure.

FIG. 4 is a flow diagram illustrating an example method managing a user profile of content in accordance with embodiments of the disclosure.

FIG. 5 is a flow diagram illustrating an example method of acquiring relevant content of interest in accordance with certain embodiments of the disclosure.

FIG. 6 is a flow diagram illustrating an example method of assembling a playlist of content in accordance with certain embodiments of the disclosure.

FIG. 7 is a flow diagram illustrating an example method of assembling a playlist of content for a driver and a passenger with dissimilar interest in content in accordance with certain embodiments of the disclosure.

FIG. 8 is a simplified schematic diagram of an example mechanism for selecting and assembling a playlist for a driver and a passenger with dissimilar content preferences in accordance with embodiments of the disclosure.

### DETAILED DESCRIPTION OF EMBODIMENTS OF THE INVENTION

Embodiments of the disclosure are described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the disclosure may provide systems, apparatus, and methods for providing customized content for to the driver and/or passengers of the vehicle. In one aspect, the content preferences of particular individuals, such as the driver and/or passengers, may be learned. In another aspect, the content preferences in a particular context of using the vehicle may be learned. Upon learning preferences of content associated with either a driver and/or passengers or the context in which the vehicle is used, content of potential interest may be acquired. Furthermore, a playlist may be assembled based at least in part on the available content and identification of at least one of the driver and/or passengers in the vehicle and/or the context within which the vehicle is used.

For the purposes of this disclosure, the content may include any suitable content including, but not limited to, audio, video, still pictures, interactive games, movies, radio, television, podcasts, or combinations thereof. The playlist may be a time sequence of content that is provided and/or rendered to individuals within the vehicle. The individuals within the vehicle may include the driver and/or passengers. Embodiments of the disclosure may include user profiles that are linked to one or more of the driver and/or passengers. For example, each individual may have a user profile associated therewith. It should also be noted that a particular individual may sometimes be the driver of the vehicle and at other times be a passenger within the vehicle. The context within which the vehicle is used may include the type of travel and/or the individuals within the vehicle. For example, the context may include travel to work, travel to the grocery store, or any other type of suitable usage of the vehicle. Typically, the context of travel, and the type of travel associated therewith, may be periodic and/or predictable in terms of variety of parameters. These parameters may include the distance traveled, a route traveled, the speed of travel, the time of travel, locations of travel, and/or the individuals within the vehicle. In certain embodiments, context profiles associated with the context within which the vehicle is used may be provided. For example, there may be a context profile associated with travel to work and another context profile associated with running errands.

The learning of an individual's content preference may be performed by one or more processors disclosed on the vehicle, such as processors associated with and in-vehicle infotainment (IVI) system of the vehicle. The one or more processors may be configured to identify content that is requested and/or rendered by a particular individual, a particular group of individuals, or in a particular context of travel. By identifying the content rendered and matching those rendered content to an individual, a group of individuals, or context of travel, patterns of interest associated with individuals and/or context of travel may be identified. Upon identification of the patterns associated with individuals and/or context of travel, individual interests and types of content may be ascertained. Individual interests may then be indicated in one or more profiles associated with individuals. The one or more processors may, therefore, be configured to generate one or more user profiles based at least in part on content interests of particular individuals. For example, if the one or more processors observed that a particular driver prefers to listen to hip-pop music while driving, then a user profile may be generated for that individual that indicates that individual's preference for a pop music. Additionally, the one or more processors may be configured to generate one or more context profiles based at least in part on content rendering patterns during particular usage of the vehicle. For example, if a particular group of individuals drive and/or ride to work together, such as in a carpool arrangement, and during this particular vehicle usage context, if the individuals within the vehicle preferred to listen to talk radio, then the one or more processors may be configured to generate a context profile associated with the drive in to work that indicates a preference for talk radio. The one or more processors may be configured to store profiles, such as user profiles and/or context profiles, in one or more memories associated with the vehicle.

The one or more processors may further be configured to communicate with a profile server. The profiles generated by the one or more processors may, in certain embodiments, be transmitted to the profile server. The profile server may store one or more profiles associated with a particular vehicle and/or individuals and/or context associated with the vehicle. Therefore, profiles associated with particular users or with particular contexts may be provided to the profile server for storage and later access. Furthermore, the stored profiles on the profile server may be accessed by more than one vehicle or other entities that may use the profiles as stored on the profile server. In one or more approach, processors may further be configured to access the profile server and download or otherwise receive one or more profiles from the profile server. In one aspect, the one or more processors may be configured to identify one or more individuals within the cabin of the vehicle and retrieve user profiles and/or context profiles based at least in part on the identification of the individuals within the vehicle. In another aspect of one or more processors may be configured to identify a possible context of use based on a variety of factors including, for example, the time of day when the vehicle was being used. Upon identifying a possible context of usage of the vehicle, the one or more processors may access the profile server to download a context profile corresponding to the possible context of use of the vehicle.

One or more processors may be configured to acquire one or more content based at least in part on one or more profiles, such as user profiles and/or context profiles. In one aspect, the one or more processors may identify a user's content preferences based on the user's user profile. For example, a user profile may indicate that the corresponding respective user is interested in classic rock music. Accordingly, the one or more processors may acquire content related to classic rock music, such as classic rock music singles. The one or more processors may be configured to acquire content when the one or more processors are communicatively connected to a source of content. Additionally, when the one or more processors are not communicatively coupled to a source of content, the one or more processors may wait until there is a communicative connection prior to receiving content. For example, the vehicle may not be communicatively coupled to sources of content while it is being driven on the roads. However, when the vehicle is in range of a Wi-Fi hotspot with which the one or more processors may communicate, the one or more processors may retrieve content that may be rendered to one or more users, such as drivers and/or passengers of the vehicle.

In certain embodiments, the one or more processors may be configured to retrieve content from user devices that may be associated with individuals that are associated with the vehicle. For example, an individual that drives a particular vehicle may have a laptop computer with music stored thereon. When the one or more processors of the vehicle are communicatively coupled to the laptop computer, the one or more processors may retrieve content, such as one or more music files stored on the laptop computer. In some cases, the one or more processors may only retrieve music files that may be of interest to the particular individual from a larger collection of music files that may be stored on the laptop computer based at least in part on the individual's user profile. In certain embodiments, the one or more processors may purchase content from entities that sell content, such as via the Internet.

The one or more processors may further be configured to acquire content that may be of interest to more than one individual. For example, the one or more processors may determine which of the individuals spend the most time within the vehicle and may acquire content that may be of interest to those individuals. In particular, if there are constraints on the acquisition of content, for example monetary and/or storage constraints, then the one or more processors may expend limited resources to acquire and provide content that is of interest to particular individuals, such as those individuals that spend the most amount of time within the vehicle.

When there is a library of content accessible to the one or more processors, one or more processors may be configured to generate a playlist, or otherwise a sequence of content to be rendered to one or more users of the vehicle, based at least in part on the available content and profiles associated with the one or more users. In this case, the one or more processors may be configured to identify individuals that may be present within the vehicle.

In certain embodiments, one or more processors may be configured to access and utilize more than one profiles, such as any combination of more than one of user profiles and/or context profiles. For example, if two individuals, such as a driver and passenger, are in the vehicle and the user profile corresponding to each of the two individuals may be accessed and utilized by the one or more processors to determine content preferences of the two individuals. One or more processors may acquire content and/or generate a playlist based at least in part on the more than one profile. For example, common interests in content of the two individuals may be determined and that content of common interest may be acquired and/or rendered by the one or more processors. In certain other embodiments, specific content that may be of interest to occupants of the vehicle during a particular usage of the vehicle may be associated with a particular context profile and a playlist may be generated according to that context profile. For example, a content profile associated with a group of colleagues carpooling to work may include news and/or talk radio and a playlist may be generated by the one or more processors that include news and/or talk radio programming.

Example embodiments of the disclosure will now be described with reference to the accompanying figures.

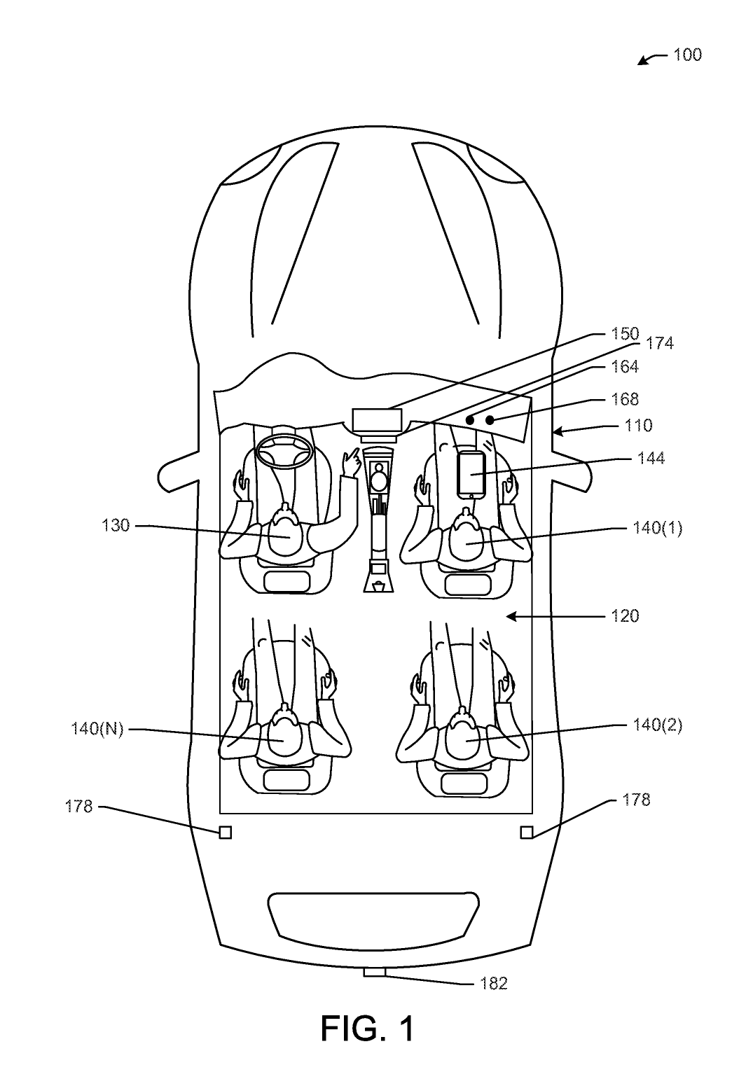

Referring now to FIG. 1, an example vehicle 100 configured to perform the methods in accordance with embodiments of the disclosure as discussed herein. The vehicle 100 may include a body 110 and a cockpit housed within the body 110 that may be configured to hold one or more occupants of the vehicle 100, such as the driver 130 and passengers 140(1)-(N), collectively or individually referred to herein as 140. One or more of the driver 130 and/or passenger 140 may have a user device 144. Although depicted with one of the passengers 140(1), it will be appreciated that any of the occupants 130, 140 of the vehicle 100 may have a user device 144. The vehicle may also include an in-vehicle infotainment (IVI) system 150 that may be configured to provide information and/or entertainment, such as content and/or media, to the occupants 130, 140 of the vehicle 100. The vehicle 100 may further include one or more sensors, such as a microphone 164 and/or an image sensor 168, that may be communicatively coupled to the IVI system and may provide sensor signals, such as audio and/or image signals, to the IVI system 150. The vehicle 100 may yet further include I/O devices, such as a control panel 174, to enable user and/or vehicle occupant 130, 140 interactions with the IVI system 150. In certain embodiments, the control panel 174 may include a display screen on which images and/or video may be displayed. In the same or further embodiments, the control panel 174 may have a touch sensitive display screen and/or peripheral input elements for accepting user based input. The vehicle may still further include one or more output devices, such as speakers 178 that may enable rendering of content and/or media to occupants 130, 140 of the vehicle 100.

While the vehicle 100 is depicted herein as a car, it will be appreciated that the vehicle, in certain embodiments of the disclosure, may include, but is not limited to, a car, a truck, a light-duty truck, a heavy-duty truck, a pickup truck, a minivan, a crossover vehicle, a van, a commercial vehicle, a private vehicle, a sports utility vehicle, a tractor-trailer, an aircraft, an airplane, a jet, a helicopter, a space vehicle, a watercraft, or any other suitable vehicle. It will further be appreciated that embodiments of the disclosure may also be utilized in other environments, such as non-vehicular environments, where media content preferences may be learned, media content may be acquired, and playlists may be generated.

It will further be appreciated that the number of occupants 130, 140 in the vehicle 100 may vary. For example, at some times, only the driver 130 may be present in the vehicle 100. At other times, there may be one or more passengers 140, in addition to the driver 130, in the vehicle 100. In yet other instances, there may be one or more passengers 140 in the vehicle 100 without the driver 140, such as when the vehicle 100 may be parked in a parking lot without a driver 130 in the vehicle 100. Furthermore, a particular individual may sometimes be a driver 130 and sometimes be a passenger 140 in the vehicle 100. For example, in a family situation, either the mother or the father may be a driver 140 and one or more children may be the passenger(s) 140.

It should also be noted that although particular media content and/or segments thereof may be discussed herein, embodiments of the disclosure include any variety of media content including audio, video, images, sound, games, messaging, or the like. The content may further include over-the-air radio broadcasts, such as traditional analog broadcasts, such as amplitude modulation (AM), frequency modulation (FM), and/or short wave broadcasts, as well as high-definition (HD) radio. Additionally, it will be appreciated that the media content as discussed herein may be rendered to a user and/or occupant of the vehicle 100 via any suitable input, output, and/or input/output (I/O) device including speakers 178, display screens, projections, wireless communications with user devices, control panel 174, or the like. For example, speakers 178 may be configured to receive signals associated with content, such as signals corresponding to music, and render the content based at least in part on the received signals. In certain embodiments, the signals may be received from the IVI system 150 or other suitable information and/or content systems of the vehicle 100. In some cases, video and/or images may be rendered on the control panel 174 and/or display screens provided within the cockpit 120 of the vehicle 100.

While a single user device 144 is depicted in FIG. 1, it will be appreciated that there may be any number of user devices 144 associated with any of the occupants 130, 140 of the vehicle 100. Indeed, a particular occupant 130, 140 may, in some cases have more than one user device 144. In other cases, some occupants 130, 140 may have one or more user devices 144 and other occupants 130, 140 may not have any user devices associated with them. The user device(s) 144 may be configured to communicate with the IVI system 150 of the vehicle 100. The user devices 144 may further be configured to provide identification of the user device 144 and/or the associated occupant 130, 140 to the IVI system 150. The user device 144 may be any variety of personal communications and/or personal entertainment devices including, but not limited to a laptop computer, a tablet computer, a netbook computer, a personal digital assistant (PDA), or a smartphone.

The IVI system 150 as depicted herein may be configured to provide a variety of functions associated with information, entertainment, and/or vehicle 100 functions. However, a variety of other systems and/or distributed processing capabilities may perform the functions and methods associated with the IVI system 150 as described herein, in accordance with embodiments of the disclosure. For example, the processes as described to be performed by the IVI system 150 may alternatively be performed by one or more processors disposed on the vehicle 100, such as one or more processors associated with a vehicle music/stereo system. In accordance with the systems and methods disclosed herein, the IVI system may be configured to learn content preferences of one or more occupants 130, 140 and/or users of the vehicle, learn content preferences associated with one or more driving contexts, acquire one or more content based on at least in part on one of learning content preferences associated with particular occupants and/or driving contexts, and assembling a playlist based at least in part on one of learning content preferences associated with particular occupants and/or driving contexts.

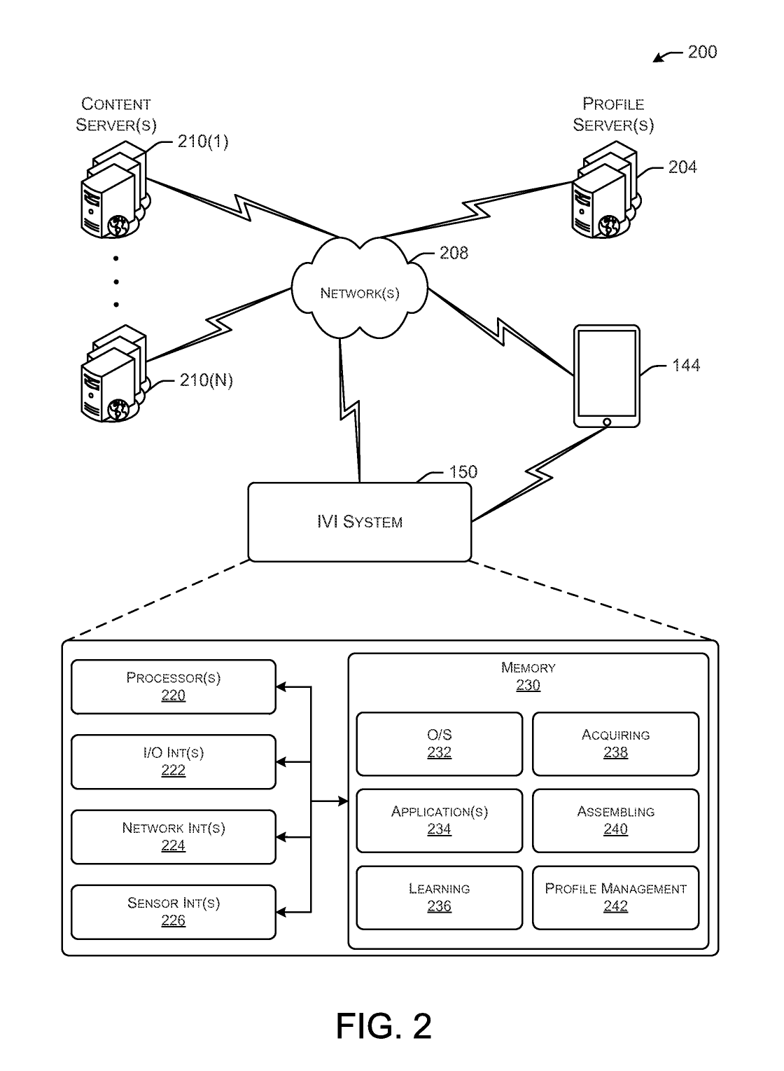

Referring now to FIG. 2, a simplified block diagram illustrating an example architecture 200 for providing customized content within the vehicle 100 of FIG. 1 is described. The IVI system 150, or other suitable information and/or entertainment system of the vehicle 100, may be communicatively linked to the one or more user devices 144 and to one or more network(s) 208. The architecture 200 may further include one or more profile servers 204 and one or more content servers 210(1)-(N), collectively or individually referred to herein as content server 210. The profile servers 204 and the content servers 210 may be communicatively linked to the IVI system 150 via the networks 208 or other suitable communicative connections. It should be noted that in certain embodiments, the IVI system 150 may only intermittently be connected to the networks 208. Therefore, the IVI system 150 may not always be able to access the profiles servers 204 and/or the content servers 210.

The networks 208 may include any one or a combination of different types of suitable communications networks, such as cable networks, the Internet, wireless networks, cellular networks, and other private and/or public networks. Furthermore the networks 208 may include any variety of medium over which network traffic is carried including, but not limited to, coaxial cable, twisted wire pair, optical fiber, hybrid fiber coaxial (HFC), microwave terrestrial transceivers, radio frequency communications, satellite communications, or combinations thereof. It is also noted that the described techniques may apply in other client/server arrangements (e.g., set-top boxes, etc.), as well as in non-client/server arrangements (e.g., locally stored software applications, etc.).

The IVI system 150 may include one or more processors 220, one or more I/O device interfaces 222, one or more network interface(s) 224, one or more sensor interface(s) 226, and/or one or more memories 230.

In some examples, the processors 220 of the IVI system 150 may be implemented as appropriate in hardware, software, firmware, or combinations thereof. Software or firmware implementations of the processors 220 may include computer-executable or machine-executable instructions written in any suitable programming language to perform the various functions described. Hardware implementations of the processors 220 may be configured to execute computer-executable or machine-executable instructions to perform the various functions described. The one or more processors 220 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The IVI system 150 may also include a chipset (not shown) for controlling communications between the one or more processors 220 and one or more of the other components of the IVI system 150. The one or more processors 220 may also include one or more application specific integrated circuits (ASICs) or application specific standard products (ASSPs) for handling specific data processing functions or tasks. In certain embodiments, the IVI system 150 may be based on an Intel® Architecture system and the one or more processors 220 and chipset may be from a family of Intel® processors and chipsets, such as the Intel® Atom® processor family.

The input/output (I/O) device(s) or user interface(s), such as the control panel 174, may be controlled via the one or more I/O device interfaces 222. The network interfaces(s) 224 may allow the IVI system 150 to communicate via the one or more network(s) 208 and/or via other suitable communicative channels. For example, the IVI system 150 may be configured to communicate with stored databases, other computing devices or servers, user terminals, other devices on the networks 208 and/or repositories of user profiles and/or content. The sensor interface(s) 226 may enable the IVI system 150 to receive and interpret signals from the one or more sensors, such as sensors 164, 168.

The memory 230 may include one or more volatile and/or non-volatile memory devices including, but not limited to, magnetic storage devices, read only memory (ROM), random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof.

The memory 230 may store program instructions that are loadable and executable on the processor(s) 220, as well as data generated or received during the execution of these programs. Turning to the contents of the memory 230 in more detail, the memory 230 may include one or more operating systems (O/S) 232, an applications module 234, a learning module 236, an acquiring module 238, an assembling module 240, and/or a profile module 242. Each of the modules and/or software may provide functionality for the IVI system 150, when executed by the processors 220. The modules and/or the software may or may not correspond to physical locations and/or addresses in memory 230. In other words, the contents of each of the modules 232, 234, 236, 238, 240, 242 may not be segregated from each other and may, in fact be stored in at least partially interleaved positions on the memory 230.

The operating system module 232 may have one or more operating systems stored thereon. The processors 220 may be configured to access and execute one or more operating systems stored in the operating system module 232 to operate the system functions of the IVI system 150. System functions, as managed by the operating system may include memory management, processor resource management, driver management, application software management, system configuration, and the like. The operating system may be any variety of suitable operating systems including, but not limited to, Google® Android®, Microsoft® Windows®, Microsoft® Windows® Server®, Linux, Apple® OS-X®, or the like. The application module 234 may contain instructions and/or applications thereon that may be executed by the processors 220 to provide one or more services to the user. These instructions and/or applications may, in certain aspects, interact with the operating system module 232 and/or other modules of the IVI system 150.

The learning module 236 may have instructions stored thereon, that when executed by the processors 220, configure the IVI system 150 to learn the content preferences of particular users and/or occupants 130, 140 of the vehicle. Furthermore, the processors 220 may be configured to learn content preferences for particular drive contexts. For example, the processors 220 may be configured to determine the content preferences of the occupants 130, 140 of the vehicle 100 by observing the content selections when particular occupants 130, 140 are in the vehicle 100.

The acquiring module 238 may include instructions stored thereon, that when executed by the processors 220, configure the IVI system 150 to acquire content that may later be rendered to one or more occupants of the vehicle 100. The processors 220 may acquire the content based at least in part on recognizing individuals that regularly occupy the vehicle 100 and content interests and/or preferences associated with those individuals. The processors 220 may, therefore, access one or more user and/or context profiles to determine content that would be rendered to occupants 130, 140 of the vehicle 100. Upon analyzing the one or more user and/or context profiles, the processors 220 and IVI system 150 may acquire content. In some cases, content that is most likely to get rendered may be acquired. For these cases, the IVI system 150 may estimate the likelihood of various entities and or contexts associated with a particular content in acquiring the content. In certain embodiments, the processors 220 may be configured to spend a predetermined amount of resources, such as money, in the acquisition of content. In so doing, the processors 220, by executing instructions stored in the acquiring module 238, may continue to acquire content to which the IVI system 150 does not already have access until a particular amount of money is spent in acquiring the content. For example, the most likely content that the IVI system 150 does not already have may be acquired until resources and/or money for acquiring the content has been spent. The processors 220 may further be configured to receive and/or acquire content when the IVI system 150 is communicatively coupled to the networks 208 or other suitable communicative links. Therefore, in situations where the network 208 connections are only made intermittently, the IVI system 150 may wait to acquire content when the networks 208 are established for acquiring content.

As depicted herein, the processors 220 may acquire content from the content servers 210 via the networks 208 or other suitable communicative links. The content servers 210 may be any variety of suitable sources of content including, but not limited to media and/or content retailers, public domain content distributers, content renters, other electronic devices associated with the owner and/or user of the vehicle 100, or the like. For example, the IVI system 150 may be configured to establish a communicative connection with a user device, such as a laptop computer storing digital music, associated with the user and/or occupants 130, 140 of the vehicle 100 via the networks 208 and receive content from that user device. In some cases, the IVI system 150 may be configured to establish a direct communicative connection with a user device 144 as depicted. As another example, the IVI system 150 and the processors 220 thereon may be configured to purchase content from online sellers of content. In yet another example, the IVI system 150 may be configured to access content via an Internet streaming radio station.

The instructions stored in the acquiring module 238, when executed by the processors 220, may enable the processors 220 to enforce digital rights and/or engage in the management of digital rights associated with copyrighted content. Therefore, the IVI system 150, by utilizing digital rights management (DRM) technologies, may be configured to prevent the theft of copyrighted content and/or limit the rendering of content in accordance with usage rules associated with the content.

The assembling module 240 may have instructions stored thereon that when executed by the processors 220 configure the IVI system 150 to assemble a progression of content to be rendered, such as in the form of a playlist. The processors 220 may be configured to determine the occupants 130, 140 in the cabin 120 of the vehicle 100 and determine content to be rendered based at least in part on the identified occupants 130, 140 and/or conditions under which the vehicle 100 is operated. The processors 220 may be configured to provide a playlist or sequence of content based at least in part on one or more user profiles of occupants 130, 140 of the vehicle and/or one or more context profiles associated with the context in which the vehicle 100 is operated. The processors 220 may access the content that is available to the IVI system 150, such as content that may be stored in the memory 230 of the IVI system 150. In some cases, the available content may be stored and accessed from one or more user device 144 with which the IVI system 150 is communicatively linked. In other cases, the content may be available to the IVI system 150 via broadcast, such as in the case of broadcast radio stations and/or Internet radio stations.

The assembling module 240 may further include instructions stored thereon that when executed by the processors 220 configure the IVI system 150 to assemble a playlist based at least in part on a driving context. The driving context may relate to a known current use of the vehicle 100 or a predicted current use of the vehicle 100. For example, the IVI system 150 may be configured to generate a playlist based on the context of the trip, such as the duration of the trip. Therefore, in this case, the IVI system 150 may select a particular number, sequence, and/or type of content based at least in part on the predicted duration of the current trip in addition to the factors of occupant 130, 140 content preferences and content availability. If the duration of the trip were to change from what is predicted by the IVI system 150, such as due to traffic conditions, the IVI system 150 may modify the generated playlist accordingly.

The profile management module 242 may have instructions stored thereon that when executed by processors 220 enable the IVI system 150 to create, analyze, and/or manage various aspects of user profiles and/or driving context profiles. A user profile associated with a particular user or occupant 130, 140 of the vehicle 100 may indicate content preferences associated with the user 130, 140. Similarly, a context profile associated with a particular driving context may indicate content preferences associated with a particular driving context, such as driving to work, heavy traffic, light traffic, or the like. The user and/or context profile may provide information associated with content and/or media of interest associated with particular occupants 130, 140 of the vehicle 100 and/or context of driving the vehicle 100. The profile management module 242 and the instructions stored thereon may enable the processors 220 to observe content consumption behavior associated with a particular user 130, 140 during operation of the vehicle 100 or under particular context of driving. The processes enabled by the profile management module 242 may, therefore, cooperate with the processes enabled by the learning module 236 to identify occupant 130, 140 behavior associated with content rendered within the vehicle 100. In certain cases the observed behavior may be codified into corresponding parameters that constitute a user and/or context profile and may further be used to create and/or update one or more user and/or context profiles. For example, if the processors 220 detect that a particular type of music was listened to repeatedly when a particular driver 140 was driving the vehicle 100, then the IVI system 150 may codify that content preference into a parameter associated with that driver 140 in his/her user profile. The user profile for a particular user may also have parameters associated with the user being a driver or a passenger. In certain cases, certain individuals may only be a passenger, such as children who are not legally allowed to drive, and in other cases, a particular individual may be either a passenger at some times or a driver of the vehicle 100 at other times. The user characteristics and preferences may be different based upon whether a particular individual is a driver 130 or a passenger 140.

The profile manager module 242 may further include instructions that when executed by the processors 220 enable the processors 220 to access one or more user and/or context profiles associated with occupants 130, 140 within the cabin 120 of the vehicle 100. In certain embodiments the user and/or context profiles associated with the occupants 130, 140 may be stored in memory 230 locally on the IVI system 150 or, in other cases, the user and/or context profiles may be stored on a remote server such as the profile server 204. In the case where the user and/or context profile is stored on a profile server 204, the IVI system 150 may download the user and/or context profile via the one or more networks 208 or other suitable communicative connections to the profile server 204. In some cases, the communicative link to the one or more networks 208 may be intermittent for the IVI system 150. For example, the IVI system 150, in some cases, may not be able to access the networks 208 or the profile server 204 when the vehicle 100 is in operation and being driven. However, the IVI system 150 may be able to access the one or more networks 208 when the vehicle 100 is parked in proximity of the vehicle owner's house. In these cases, when the IVI system 150 has access to the profile servers 204 intermittently, the IVI system 150 may download the appropriate user and/or context profiles when communicative connection can be established with the profile servers 204.

The IVI system 150 may also be configured to upload user and/or context profiles to the profile server 204. For example, if a particular user and/or context profile is updated during use and learning an observation, the new user and/or context profile may be transmitted to the profile server 204 for update. By saving user and/or context profiles to the profile server 204 remotely from the IVI system 150 it is possible for a particular individual to access that profile from multiple vehicles. For example, a particular user 130, 140 may own two vehicles and a profile generated on the first vehicle may be uploaded to the profile server 204 and when the user 130 uses the second vehicle the same profile may be downloaded to that second vehicle 100.

It will be appreciated that there may be overlap in the functionality of the instructions stored in the O/S module 232, an applications module 234, a learning module 236, an acquiring module 238, an assembling module 240, and/or a profile module 242. In fact, the functions of the aforementioned modules 232, 234, 236, 238, 240, 242 may interact and cooperate seamlessly under the framework of the IVI system 150. Indeed, each of the functions described for any of the modules 232, 234, 236, 238, 240, 242 may be stored in any module 232, 234, 236, 238, 240, 242 in accordance with certain embodiments of the disclosure. Further, in certain embodiments, there may be one single module that includes the instructions, programs, and/or applications described within the O/S module 232, an applications module 234, a learning module 236, an acquiring module 238, an assembling module 240, and/or a profile module 242.

It will be appreciated that the IVI system 150 is an example system for the implementation of the content preference learning, acquiring, and playlist generation systems and methods disclosed herein. In certain embodiments, the one or more processors 220 and the functionality associated therewith may be independent of the IVI system 150. In other words, in some cases, the evidence acquisition system may be a separate entity from the vehicle's IVI system 150. Therefore, the one or more processors 220 may or may not be dedicated to the IVI system 150 for providing component control signals. Therefore, in such embodiments, the processors 220 may be separate from the IVI system 150. It should also be noted that the IVI system 150 and/or the processors 220 may be part of or otherwise associated with a main computer of the vehicle 100. The software associated with the IVI system 150 may further be stored on a server or a cloud server and may be transferred to the IVI system 150 of the vehicle 100 via one or more of a wired connection, a wireless connection, a smart key, a universal serial bus (USB) drive, or the like.

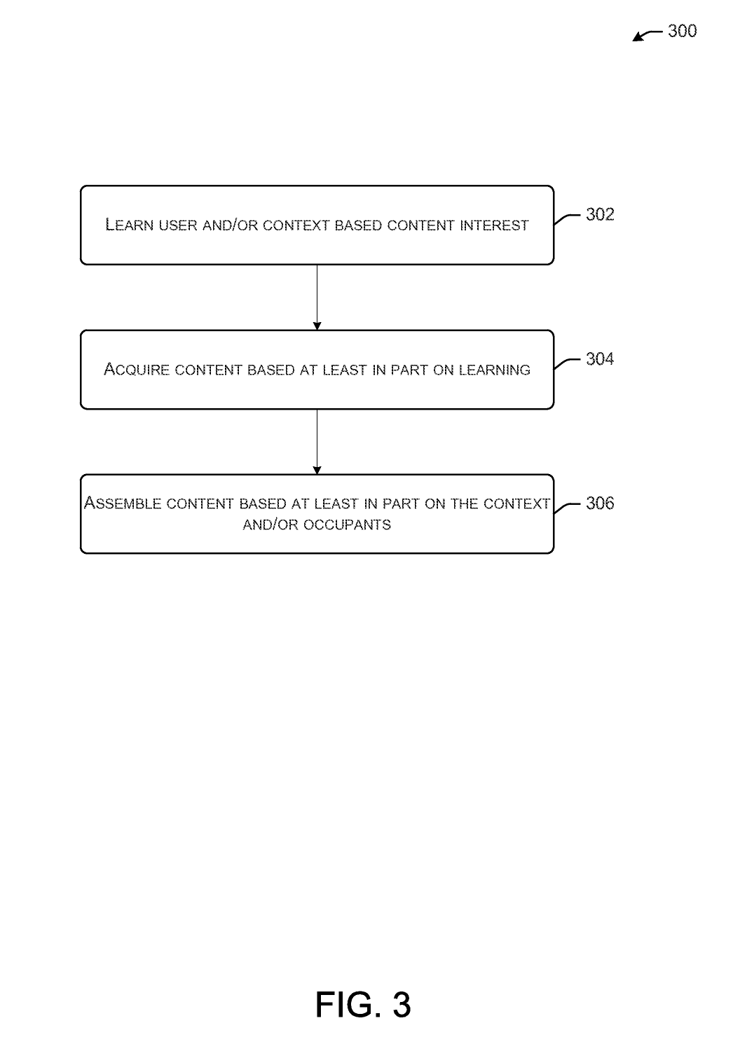

Referring now to FIG. 3, an example method 300 for assembling content based at least in part on context and occupants 130, 140 of the vehicle 100 in accordance with embodiments of the disclosure is described. Method 300 may be performed by the IVI system 150 and the processors 220 thereon or other suitable systems of architecture 200. At block 302 a user and/or context based content interest may be learned. This learning may entail identifying content that is selected for rendering during a variety of situations, such a variety of occupant 130, 140 configurations and/or driving contexts. In other words patterns of requested content in a variety of driving and occupant 130, 140 situations may be identified by the IVI system 150 and the processors 220 thereon. For example, the IVI system 150 may identify a preferred genre of music when a particular occupant 130, 140 is in the vehicle 100. As another example, the IVI system may identify a preferred sequence of content when a particular group of occupants 130, 140 are within the vehicle 100. As yet another example, the IVI system 150 may identify that a particular type of content may be rendered under a particular driving context, such as driving during a rain storm.

In certain embodiments, based at least in part on the learning of user and/or context based content of interest, the IVI system 150 and the processors 220 thereon may generate a user and/or context profile. The IVI system 150 may generate one or more parameters that are indicative of a particular user and/or group of user's content interests. The one or more parameters may be used to generate a user profile associated with one or a group of occupants 130, 140 of the vehicle 100. In some cases, a user profile may be associated with a single individual and indicate his/her content preferences. In other cases, a user profile may be associated with a group of individuals, such as a family that may ride in the vehicle 100 at the same time. In certain embodiments, the user profile may include elements and/or parameters related to information about individual or group content preferences under certain drive contexts and/or characteristics. For example, a user profile associated with a particular driver 130 may indicate a first content preference during city driving, a second content preference during highway driving, and yet another content preference during inclement weather driving.

At block 304, content may be acquired based at least in part on the learning. The IVI system 150 and the processors 220 thereon may connect to one or more content servers 210 or other sources of content via networks 208 or other communicative links to acquire content. The content acquired may be those content elements that are of interest to those individuals that use the vehicle 100 either in the capacity of a driver 130 or in the capacity of a passenger 140. For example, if a particular driver 130 of the vehicle has been identified to prefer a particular genre of music by performing the process of block 302, then that genre of music may be downloaded by the IVI system 150 from one or more content servers 210. Furthermore, the content acquired may be those content elements that are to be rendered in a particular driving context. For example, content may be acquired that may be rendered when a particular group of individuals are driving to work.

In certain embodiments, content may be acquired based at least in part on the likelihood and/or the frequency that it is likely to be rendered. In these embodiments, the IVI system 150 and the processors 220 thereon may consider both user and/or context based content preferences and the likelihood and/or frequency of a particular individual being in the vehicle 100 or the use of a vehicle in a particular context. In other words, the IVI system 150 may project the likelihood of the rendering of content based on patterns of use of the vehicle 100 for particular purposes and/or the patterns of when particular individuals are within the vehicle 100 as either the driver 130 or a passenger 140. Therefore, the IVI system 150 and the processors 220 thereon may project the expected frequency and/or probability of a particular individual being in the vehicle 100 at a future time and/or the probability of the vehicle 100 being driven in a particular context. In certain embodiments, information pertaining to the likelihood of a particular user may be provided in and/or determined from one or more parameters associated with a user profile of the particular user or of a group of users. In the same of different embodiments, the likelihood of a particular driving context may be provided in and/or determined from one or more parameters associated with a context profile. As a result, the content may be acquired based at least in part on one or more user profiles and/or content profiles that codify the content interests and/or preferences of an individual, a group of individuals, and/or a particular driving context.

At block 306, content may be assembled based at least in part on the context and/or occupants. In one aspect, the IVI system 150 and the processors 220 thereon may identify the occupants 130, 140 of the vehicle 100. In another aspect, the IVI system 150 and the processors 220 thereon may identify a particular driving context. Upon identifying at least one of the occupants 130, 140 and the driving context, the IVI system 150 may determine which acquired content from block 304 may be preferred in accordance with the learning of block 302. In certain embodiments, the identification of preferences as learned in block 302 may be based at least in part on one or more of a user profile(s) and/or context profile(s). Therefore, the IVI system 150 may ascertain the occupants 130, 140 and/or driving context and subsequently identify and/or access profiles associated with those occupants 130, 140 and/or driving contexts.

Upon identifying and/or accessing the appropriate profiles, the IVI system may apply a variety of algorithms and/or rules to parameters of the relevant profiles to determine the content to be presented and/or rendered to the occupants 130, 140 of the vehicle. For example, if there are two occupants 130, 140 in the vehicle, the IVI system 150 and the processors 220 thereon may access the two corresponding respective user profiles of those two occupants 130, 140. Based on the two user profiles, the processors 220 may identify types of content that may be of common interest to both of the occupants 130, 140 and determine if that type of content is available to the IVI system 150 for rendering to the occupants. If such content of mutual interest is available, then that content of mutual interest may be included in a generated playlist. The playlist may then be used to render content to the occupants 130, 140 of the vehicle 100. In another example, the IVI system 150, based at least in part on a variety of sensor signals may determine that the vehicle 100 is engaged in a high traffic city driving operation. The user profiles and/or context profiles corresponding to the occupants 130, 140 and the identified driving context may indicate providing content that does not distract the driver 130 or other occupants 140 within the vehicle 100 that may be assisting the driver 130. In this case, the IVI system may cease rendering content to the occupants 130, 140 of the vehicle while there is an indication that the driver 130 may be busy with the functions of driving. In some cases, different content may be rendered to different occupants of the vehicle 100. For example, a video may be rendered to an occupant 140 in the back seats of the cabin 120 while music may be rendered to occupants 130, 140 in the front seats of the cabin 120.

In certain examples, when the driver 130 enters the vehicle 100 for a trip for which the context may be predicted by the IVI system 150 or when it is close to the trip, the IVI system 150 may dynamically assemble a playlist including new content that it has acquired since the last trip. The playlist itself can take various forms. In one example, it may be an ordered listing of the content with titles that from which the user (occupants 130, 140) is able to navigate to pick and choose content. It may also be snippets, segments, and/or portions of the content. The snippets, segments, and/or portions may be chosen by the IVI system 150 based at least in part on the user's preferences. For example, if the driver 130 is interested in world news as opposed to local news, only the world news snippets may be segmented out of the available content and assembled for rendering to the occupants 130, 140. In the same or other cases, assembling together different content may rely on the knowledge of the estimated drive time which the IVI system 150 may predict and/or estimate based at least in part on one or more of the drive context and/or information related to the user's schedule or a routine nature of the trip.

It should be noted, that the method 300 may be modified in various ways in accordance with certain embodiments of the disclosure. For example, one or more operations of method 300 may be eliminated or executed out of order in other embodiments of the disclosure. Additionally, other operations may be added to method 300 in accordance with other embodiments of the disclosure.

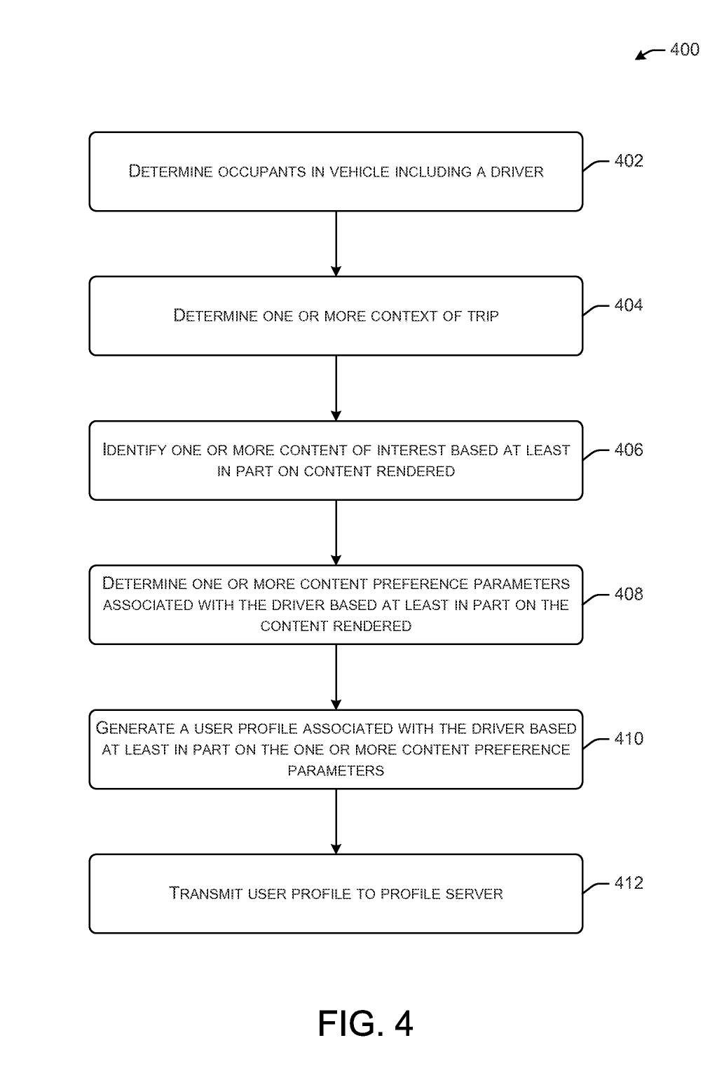

Referring now to FIG. 4, an example method 400 of generating a user profile in accordance with embodiments of the disclosure is discussed. The method 400 may be executed by the IVI system 150 and the processors 220 thereon in cooperation with other entities of the architecture 200. Method 400 may be an example implementation of block 302 of method 300 of FIG. 3. At block 402, occupants within the vehicle, including a driver, is determined. As stated earlier, the occupants 130, 140 may be identified by any suitable mechanism.

The identification of occupants 130, 140 may be performed by detecting one or more user devices 144 corresponding to particular individuals. The identification of the user devices 144 may be performed wirelessly or with a hard wired communicative connection, such as one involving placing a user device 144 in a cradle. For example, a particular driver 130 of the vehicle 100 may have a smartphone 144 that may communicate with the IVI system 150 of the vehicle and based upon the communications, the IVI system 150 may identify that user device 144 in the form of a smartphone, and further identify the individual 130 associated with that user device 144 as being within the vehicle 100. Therefore, the IVI system 150 may identify occupants 130, 140 of the vehicle 100 based, at least in part, on user devices 144 that are detected within the vehicle 100 such as via communicative links and/or communications between the user device and the IVI system 150. The user devices 144 may communicate with the IVI system 150 using any suitable mechanism for communications, such as wireless communications via Bluetooth or Wi-Fi Direct. The IVI system may further identify occupants 130, 140 of the vehicle 100 based upon image processing mechanisms. For example, the IVI system 150 may receive signals from the image sensor 168 and based upon facial recognition technology, be able to determine users 130, 140 that may be within the cabin 120 of the vehicle 100. As another example, the IVI system 150 may receive signals from the microphones 164 and based upon voice recognition technology, be able to determine users 130, 140 that may be within the cabin 120 of the vehicle 100. As yet other examples, occupants 130, 140 of the vehicle 100 may be identified using seat pressure sensors, thermal sensors, thermal imaging sensors, electrocardiogram (ECG) sensors, or combinations thereof.

At block 404, one or more context of the trip and/or drive may be determined. The IVI system 150 and the processors 220 thereon may determine this information from a variety of factors, including sensor data and/or identifying the time of day during when the vehicle 100 is in operation. For example, the IVI system 150 may receive sensor inputs from sensors such as a light detection and ranging (LIDAR) detectors, a radio detection and ranging (RADAR) detector, a sound detection and ranging (SONAR) detector, accelerometers, global positioning satellite (GPS), or the like. In some cases, the external sensors signals may indicate the acceleration, deceleration, angular velocity, slip angle, roll, and/or yaw rate of the vehicle and further indicate a range to one or more other vehicles or structures on a roadway. Based on these drive characteristics, the IVI system may be configured to determine the context of the driving. For example, if the sensor signals indicate that the vehicle is operating at a relatively high speed with little or no turns, then the IVI system may determine that the vehicle 100 is engaged in highway driving. Additionally, the driving context may be determined from a recognized temporal and/or spatial pattern of driving. For example, the IVI system 150 and the processors thereon may recognize that the vehicle 100 is operated for driving to and from work at approximately the same time on weekday mornings and afternoons. As another example, the IVI system 150 may further recognize and/or predict, from a sequence of spatial and/or geographic checkpoints, the destination of a particular trip. Checkpoints along a travel route, such as checkpoints determined from GPS readings, may be used to determine the travel and/or driving context. In a specific example, checkpoints along a particular route may be recognized along a particular route may be recognized as a “trip to grandma's house.”

At block 406, one or more content of interest may be identified based at least in part on content rendered. In this case, the content rendered may be content that is selected by the occupants 130, 140 of the vehicle 100. In other words, the IVI system 150 and the processors 220 thereon may observe content that is rendered in the presence of particular occupants 130, 140 and/or under particular driving contexts. Therefore, a correlation and/or correspondence between selected content and one or more of occupants 130, 140 of the vehicle 100 and of driving contexts may be determined from the selection of content while there are occupants 130, 140 in the vehicle 100 and/or the vehicle 100 is in use.

At block 408, one or more content preference parameters associated with the driver may be determined based at least in part on the content rendered. In other words, the content preference parameters may codify the driver's content preferences. The content preference parameters may further capture preferences that may be influenced by the driving context and/or other occupants 140 of the vehicle 100.

At block 410, a user profile associated with the driver may be generated based at least in part on the one or more content preference parameters. In one aspect, the user profile may be a collection of the generated one or more content preference parameters. Alternatively, the user profile may be derived from the one or more content preference parameters.

At block 412, the user profile may be transmitted to a profile server. In certain embodiments, the user profile may be transmitted wirelessly via antennas disposed on the vehicle 100. The user profile may further be transmitted in a variety of suitable formats and/or protocols including, for example, DRSC, Bluetooth, Wi-Fi Direct, and/or Wi-Fi. In certain embodiments, the process of block 412 may be optional. Alternatively, the user profile may be stored locally on the vehicle 100 and/or the IVI system 150, such as in memory 230.

It should be noted, that the method 400 may be modified in various ways in accordance with certain embodiments of the disclosure. For example, one or more operations of method 400 may be eliminated or executed out of order in other embodiments of the disclosure. Additionally, other operations may be added to method 400 in accordance with other embodiments of the disclosure.

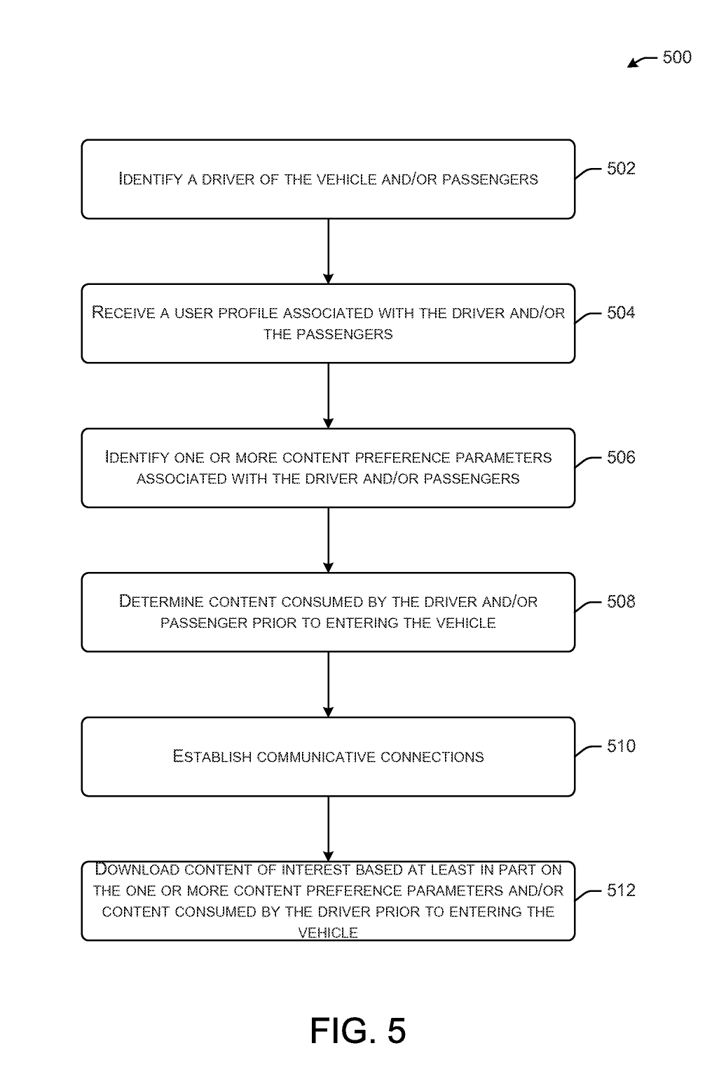

Referring now to FIG. 5, an example method 500 for acquiring content of interest in accordance with certain embodiments of the disclosure is described. The method 500 may be performed by the IVI system 150 or other systems and/or subsystems of the architecture 200. At block 502, a driver and/or passengers of the vehicle may be identified. As discussed above, the identification of drivers 130 and/or passengers 140 may be performed by a variety of suitable techniques. The identification of the occupants 130, 140 may be by identifying user devices 144 corresponding to the respective occupants 130, 140. Alternatively, the identification may be based at least in part on a variety of sensor signals received by the IVI system 150 and/or the processors 220 thereon. Such sensor signals may include signals from microphones 164, image sensors 168, seat pressure sensors, thermal sensors, thermal imaging sensors, electrocardiogram (ECG) sensors, or the like.

At block 504, a user profile associated with the driver and/or the passengers may be received. The user profile may be retrieved by the IVI system 150 and the processors 220 thereon from the memory 230 or the profile servers 204. In the cases, where the user profile is retrieved from the profile servers 204, the process of retrieving may be performed only when the IVI system 150 can establish communicative connections with the profile servers 204, such as via networks 208. The user profile may be received by the IVI system 150 in the form of one or more data packets.

At block 506, one or more content preferences parameters associated with the driver and/or passengers may be identified. As discussed above, the user profiles associated with each of the driver 130 and the passenger(s) 140 may have a variety of content preference parameters associated with them. One or more of these content preference parameters may be identified by IVI system 150 and the processors 220 thereon. From these content preference parameters, the IVI system 150 may be able to ascertain the content preferences of the occupants 130, 140.

At block 508, content consumed by the driver and/or passengers prior to entering the vehicle may be determined. In other words, the IVI system 150 may receive information associated with what content was rendered to the occupants of the vehicle 100 prior to the occupants 130, 140 entering the vehicle 100. In some case, the IVI system may receive information pertaining to content that was rendered to the occupants 130, 140 just prior to entering the vehicle 100. In some cases, this information pertaining to content that is relatively recently rendered to the occupants 130, 140 may be received by the IVI system 150 from one or more user devices 144. If content was rendered from one or more of the user devices 144 to one or more of the occupants 130, 140, then that information of which content was rendered may be transmitted from the user devices 144 and received by the IVI system 150. In some cases, the user device on which content is rendered to an occupant 130, 140 prior to entering the vehicle 100 may to be brought into the vehicle. In these cases, the IVI system 150 may receive one or more messages from these user devices via the networks 208 and/or other communicative links that indicate the content that was recently rendered to a particular user and/or occupant 130, 140 of the vehicle 100. For example, if a particular individual was listening to the radio at home and then went into his/her vehicle 100, the IVI system 150 of the vehicle 100 may receive an indication of songs that were played to the individual on his/her radio at home prior to that individual getting into the vehicle 100. Therefore, the IVI system 150 may have information related to content rendered to one or more occupants 130, 140 of the vehicle 100.

At block 510, communicative connections may be established. These communicative connections may be for the purposes of transmitting and/or receiving communications and/or content to or from one or more sources of content, such as content servers 210. At block 512, content of interest may be downloaded based at least in part on the one or more content preference parameters and the content consumed by the driver and/or the passengers prior to entering the vehicle. The IVI system 150 may receive and/or download content from any variety of content sources including the content servers 210 and/or one or more user devices, such as the user device that was rendering content to the occupant 130, 140 prior to the occupant 130, 140 entering the vehicle 100. Furthermore, playlists may be generated based at least in part on one or both of the content preferences and the content consumed by the occupant 130, 140 prior to entering the vehicle 100. In downloading content, the IVI system 150 and the processors 220 thereon may select content that is complimentary to the content consumed by the occupant 130, 140 prior to entering the vehicle 100. For example, if the occupant 130, 140 listened to a song part way through, the IVI system 100 may acquire the same song so that the occupant may finish listening to that song. As another example, if a child is part way through watching a movie prior to entering the vehicle 100, the child's movie may be acquired by the IVI system 150 and it may continue to be rendered to the child within the vehicle 100. As yet another example, a particular occupant 130, 140 may have been listening to music prior to entering his/her vehicle 100 and the IVI system 150 may have information related to the music rendered to the occupant 130, 140. In this case, the IVI system 150 may avoid downloading or otherwise acquiring the music that just recently was rendered to the occupant 130, 140. The IVI system 150 may further prevent putting the same content that was recently played for the occupant 130, 140 on the occupant's playlist for rendering within the vehicle 100.

It should be noted, that the method 500 may be modified in various ways in accordance with certain embodiments of the disclosure. For example, one or more operations of method 500 may be eliminated or executed out of order in other embodiments of the disclosure. Additionally, other operations may be added to method 500 in accordance with other embodiments of the disclosure.

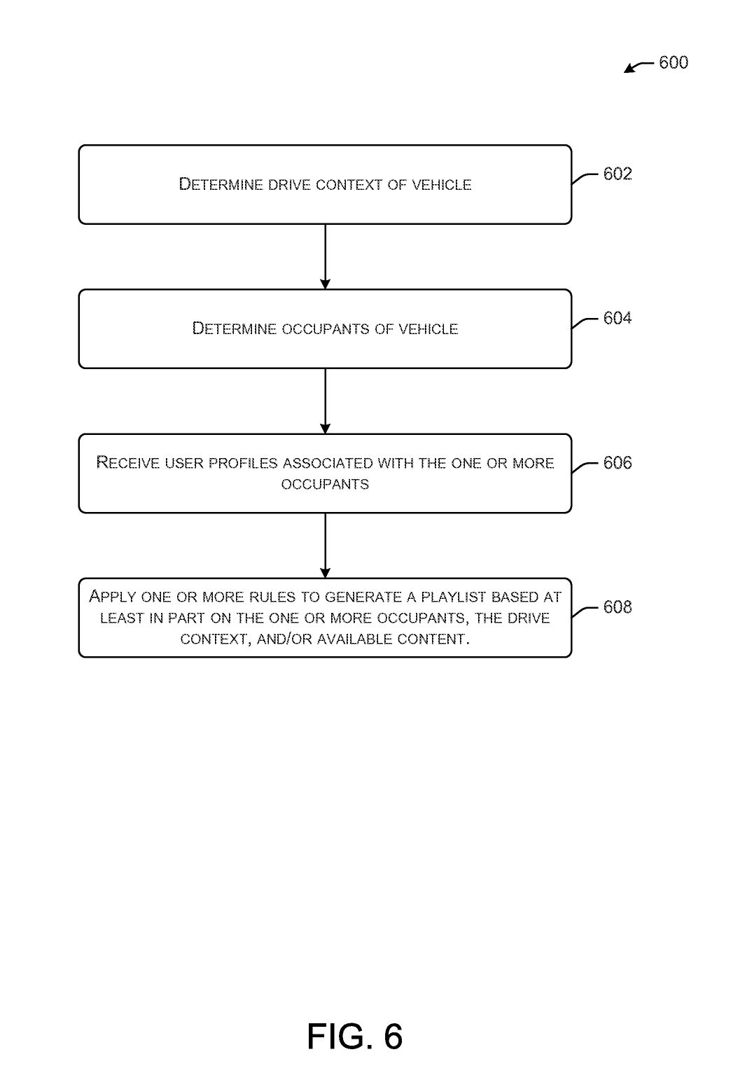

Referring now to FIG. 6, an example method 600 to generate a playlist in accordance with certain embodiments of the disclosure is described. Method 600 may be performed by the IVI system 150 and the processors 220 thereon. At block 602, the drive context of the vehicle may be determined. This may be determined from a variety of sensor signals, temporal driving patterns, and/or spatial driving patterns as discussed above in conjunction with method 400 of FIG. 4. At block 604, the occupants of the vehicle may be determined. Again this may be determined based on variety of sensor signals as described in conjunction with method 400 of FIG. 4. At block 606, user profiles associated with the one or more occupants may be received. As described above, the user profile may be received from any variety of sources, including the memory 230 and/or the profile servers 204 via the networks 208 or other suitable communicative links.

At block 608, one or more rules to generate a playlist based at least in part on the one or more occupants, the drive context, and/or available content may be applied. The generated playlist may provide a sequence of content, or portions thereof, that may be rendered to one or more occupants 130, 140 of the vehicle 100. Therefore, in this method 600 a playlist is generated based on a variety of factors that include occupant preferences 130, 140, available content, and the drive context. In some cases, the generation of the playlist may be, in some ways similar to the acquiring of content as described in conjunction with method 500 of FIG. 5.

It will be appreciated that in certain embodiments, the playlist may be assembled based at least in part on a predicted and/or estimated duration of the trip. The duration may be predicted by the IVI system 150 as part of predicting the drive context of the trip. It may be unsatisfying to occupants 130, 140 of the vehicle to only experience a portion of a particular content. Therefore, the IVI system 150 may assemble a playlist considering the predicted duration of the trip. For example, relatively long content, or segment thereof, may be rendered at a point in the playlist sequence where that content or segment may be rendered in its entirety. As an additional example, content may be selected for the playlist and/or rendered in a manner so that there is sufficient content for the entire predicted duration of the trip. As yet another example, content may be selected and sequenced for the playlist in a manner so that the appropriate mix of types and/or genre of the content is substantially maintained for the predicted duration of the trip. As a further example, content may be selected and sequenced for the playlist in a manner such that particular content may be selected for rendering near the end of a trip's predicted duration based at least in part on a relatively lower predicted user dissatisfaction if that particular content is not rendered in its entirety.

It should be noted, that the method 600 may be modified in various ways in accordance with certain embodiments of the disclosure. For example, one or more operations of method 600 may be eliminated or executed out of order in other embodiments of the disclosure. Additionally, other operations may be added to method 600 in accordance with other embodiments of the disclosure.

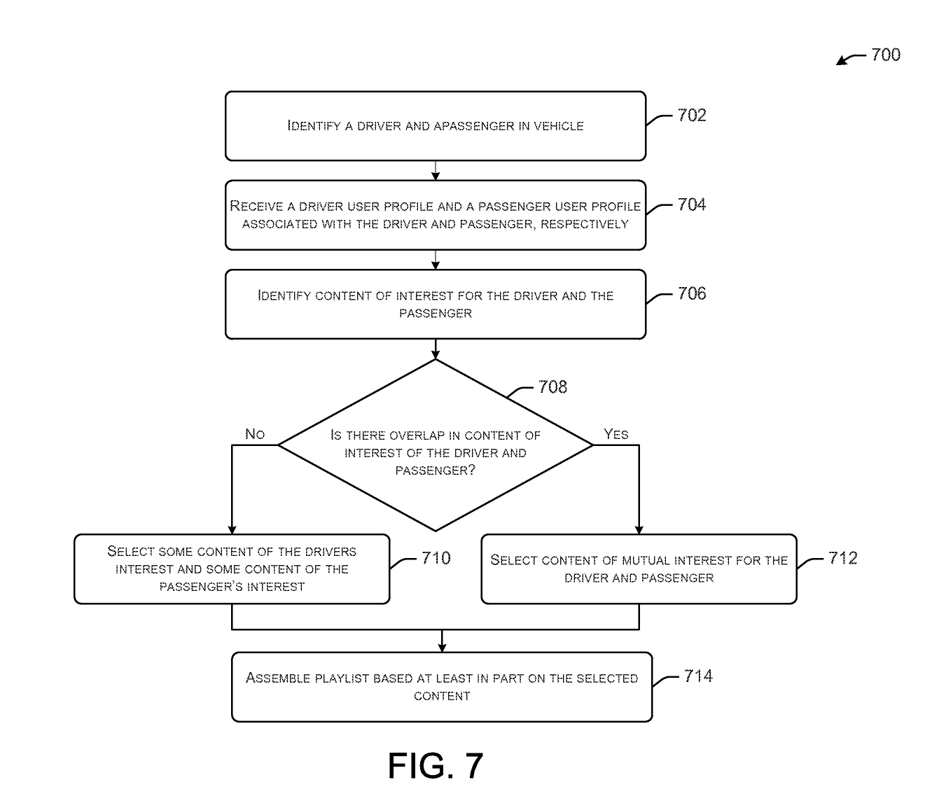

Referring now to FIG. 7, an example method 700 to generate a playlist by identifying an overlap in content interests in accordance with certain embodiments of the disclosure is described. Method 600 may be performed by the IVI system 150 and the processors 220 thereon. At block 702, a driver and passenger in the vehicle may be identified. At block 704, a driver user profile and a passenger user profile associated with the driver and the passenger, respectively, may be received. At block 706, content of interest for the driver and the passenger may be identified. The identification of occupants 130, 140, receiving and/or identifying user profiles, and determining occupant content interests therefrom, have been discussed above, and in the interest of brevity, will not be repeated here.

At block 708, it may be determined if there is an overlap in the content of interest of the driver and passenger. This may be done by comparing the content interest of the driver 130 with the content interest of the passenger 140, as determined at least in part from their respective user profiles. If at block 708 it is determined that there is no overlap in content interest, then at block 710, some content of the driver's interest and some content of the passenger's interest may be selected. On the other hand, is at block 708 it is determined that there is overlap in content interest, then at block 712, content of mutual interest of the driver and the passenger may be selected. In some alternative cases, content of overlapping interest may be selected along with some content of interest to only either of the driver 130 or the passenger 140. At block 714, the content selected by the processes of either block 710 or 712 may be assembled to generate a playlist. This playlist may subsequently be used by the IVI system to render content to the one or more occupants 130, 140 of the vehicle 100.

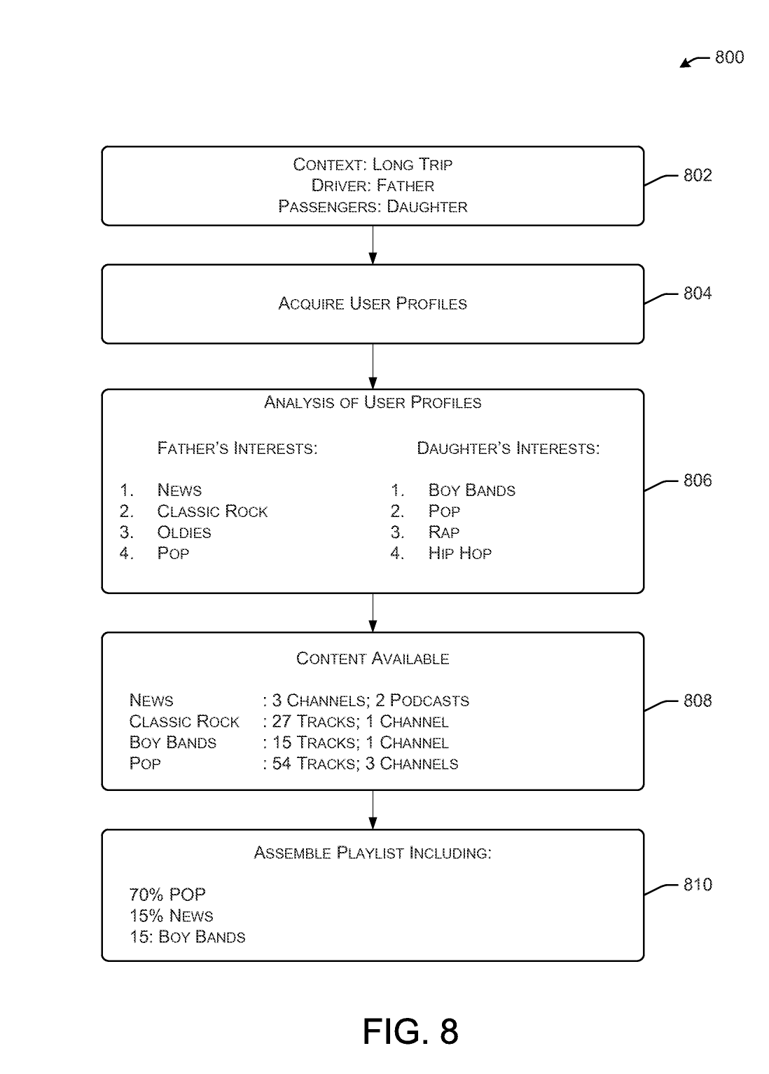

Referring now to FIG. 8, an example scenario 800 for generating a playlist in accordance with embodiments of the disclosure is described. At block 802, information about the driving and/or trip is shown. In this example trip, the driving context may be a long trip and the occupants may be a father as the driver and a daughter as the passenger. At block 804, the IVI system 150 may acquire and/or identify the user profiles associated with the father and the daughter. At block 806, the IVI system 150 may determine, based at least in part on analysis of the user profiles, both the father's and daughter's content preferences. The father's content preferences may include, for example, news, classic rock music, oldies music, and pop music. The daughter's content preferences may include boy band music, pop music, rap music, and hip hop music. At block 808, the IVI system 150 may determine what kind of content is available for rendering to the father and daughter within the vehicle 100. The IVI system 150 may determine a variety of tracks, radio broadcast channels, podcasts, and the like available for each of the genres of interest to the father and the daughter. At block 810, based at least in part on the father's and daughter's interests and the available content, the IVI system 150 may assemble a playlist. In this case, the playlist may include approximately 70% pop music content, 15% news content, and 15% boy band music content. Therefore, the algorithms for selecting the playlist may generate the playlist by selecting the largest amount of content that may be of common interest to both the father and the daughter and then some content that may be of interest only to the father or only to the daughter.

Embodiments described herein may be implemented using hardware, software, and/or firmware, for example, to perform the methods and/or operations described herein. Certain embodiments described herein may be provided as one or more tangible machine-readable media storing machine-executable instructions that, if executed by a machine, cause the machine to perform the methods and/or operations described herein. The tangible machine-readable media may include, but is not limited to, any type of disk including floppy disks, optical disks, compact disk read-only memories (CD-ROMs), compact disk rewritable (CD-RWs), and magneto-optical disks, semindiciaductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware. Additionally, in certain embodiments, a special-purpose computer or a particular machine may be formed in order to identify actuated input elements and process the identifications.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method, comprising:
identifying, by one or more processors associated with a vehicle, one or more occupants of the vehicle;
receiving, by the one or more processors, a user profile associated with at least one of the one or more occupants of the vehicle;
generating, by the one or more processors, a playlist based at least in part on the user profile.

2. The method of claim 1, further comprising determining, by the one or more processors, a driving context associated with the vehicle.

3. The method of claim 2, wherein generating the playlist is further based at least in part on the driving context.

4. The method of claim 1, wherein identifying the one or more occupants within the vehicle comprises receiving, by the one or more processors, at least one of: (i) sensor signals indicative of occupants of the vehicle; or (ii) one or more messages from one or more user devices associated with the occupants of the vehicle.

5. The method of claim 1, wherein receiving the user profile comprises receiving the user profile from at least one of a memory device or a profile server.

6. The method of claim 1, wherein the playlist identifies a sequence of content, or portions thereof, to be rendered to the one or more occupants.

7. The method of claim 1, wherein the user profile is a first user profile and the method further comprises receiving a second user profile associated with another of the at least one of the one or more occupants, and wherein generating the playlist comprises generating the playlist, by the one or more processors, based at least in part on the first and the second user profiles.

8. The method of claim 7, wherein generating the playlist further comprises identifying content, or portions thereof, of mutual interest of two of the one or more occupants, based at least in part on the first and second user profiles.

9. The method of claim 1, further comprising receiving, by the one or more processors, one or more content, or portions thereof, based at least in part on the user profile.

10. A system, comprising:
one or more sensors; and
one or more processors configured to:
receive one or more signals from the one or more sensors;
determine one or more occupants of the vehicle based at least in part on the one or more signals;
receive one or more user profiles associated with the one or more occupants of the vehicle;
determine a drive context associated with the vehicle;
generate a playlist of content based at least in part on the one or more user profiles and the drive context.

11. The system of claim 10, wherein the one or more sensors include at least one of: (i) a microphone; (ii) an image sensor; (iii) a seat pressure sensor; (iv) a thermal sensor; (v) electrocardiogram (ECG) sensors; (vi) a user device sensor.

12. The system of claim 10, wherein the user profiles comprise information associated with content preferences of the one or more occupants.

13. The system of claim 10, wherein the one or more processors are further configured to generate at least one of the one or more user profiles corresponding to a respective occupant based at least in part on content selection.

14. The system of claim 10, wherein the drive context provides information associated with at least one of: (i) destination of the vehicle; (ii) current usage of the vehicle; (iii) the type of traffic in which the vehicle is driven; (iv) velocity of the vehicle; (v) acceleration of the vehicle; (vi) deceleration of the vehicle; (vii) predicted duration of a trip.

15. The system of claim 10, wherein the content is at least one of: (i) audio; (ii) video; (iii) still pictures; (iv) interactive games; (v) movies; (vi) radio; (vii) television; or (viii) podcasts.

16. The system of claim 10, wherein the one or more processors are further configured to receive the content or portions thereof, based at least in part on the one or more user profiles.

17. One or more computer readable media comprising computer-executable instructions that, when executed by one or more processors, configure the one or more processors to:
identify an occupant of a vehicle;
receive a user profiles associated with the occupant;
determine a drive context associated with the vehicle;
generate a playlist of content based at least in part on the user profile and the drive context.

18. The computer readable media of claim 17, wherein the user profile comprises information associated with content preferences of the occupant.

19. The computer readable media of claim 17, wherein the one or more processors are further configured to receive information associated with content rendered to the occupant prior to the occupant entering the vehicle.

20. The computer readable media of claim 19, wherein the one or more processors are further configured to generate the playlist based at least in part on the information associated with content rendered to the occupant prior to the occupant entering the vehicle.

21. The computer readable media of claim 17, wherein the one or more processors are further configured to generate the user profile based at least in part on one or more content preferences of the occupant.

22. The computer readable media of claim 17, wherein the one or more processors are further configured to receive one or more content based at least in part on the user profile.
